(19) United States
(12) Patent Application Publication
(10) Pub. No.: US 2009/0189310 A1
(43) Pub. Date: Jul. 30, 2009

(54) SEMICONDUCTOR CHIP COMPRESSION MOLDING METHOD AND MOLD FOR COMPRESSION MOLDING

(76) Inventors: Shinji Takase, Kyoto-shi (JP); Tomonori Himeno, Kyoto-shi (JP)

Correspondence Address: BIRCH STEWART KOLASCH & BIRCH, PO BOX 747, FALLS CHURCH, VA, 22040-0747, US

(21) Appl. No.: 12/361,033

(22) Filed: Jan. 28, 2009

(30) Foreign Application Priority Data
Jan. 29, 2008 (JP) 2008-017000

(51) Int. Cl. B29C 43/00; B28B 7/40

(52) U.S. Cl. 264/272.17; 425/89

(57) ABSTRACT

By clamping upper and lower molds, a semiconductor chip and a stacking connection electrode are immersed in a resin material heated and molten in a cavity coated with a mold release film. The mold release film is pressed into contact with a tip portion of the connection electrode by a cavity bottom face member, so that a collective resin portion having a shape corresponding to the shape of the cavity is molded in the cavity. Accordingly, the semiconductor chip and the connection electrode are compression molded with the resin material. Here, a tip portion of the connection electrode is exposed from the collective resin portion.

This nonprovisional application is based on Japanese Patent Application No. 2008-017000 filed on Jan. 29, 2008 with the Japan Patent Office, the entire contents of which are hereby incorporated by reference.

### BACKGROUND OF TE INVENTION

1. Field of the Invention

The present invention relates to a semiconductor chip compression molding method of compression molding a semiconductor chip mounted on a substrate with a resin material and a mold for compression molding, and more particularly to a method of molding a molded substrate (a stacking package substrate) to enable formation of a POP (Package On Package) type semiconductor product and a mold that may be used in the method.

2. Description of the Background Art

Conventionally, using a mold for resin encapsulation molding of semiconductor chips by the top gate method, a required plurality of semiconductor chips (for example, a flip chip type, a wire bonding type) mounted on a substrate are individually encapsulated in individual packages (resin molded body) each corresponding to the shape of a mold cavity in the mold cavity for each semiconductor chip with a resin material. This method is performed in the following manner.

As shown in FIG. 11, a mold 101 for rein encapsulation molding by this top gate method is comprised of three molds, namely, an upper mold 102, an intermediate mold 103, and a lower mold 104.

First, mold 101 is clamped to allow each semiconductor chip 107 mounted on a substrate 106 to be fit into to be set in a mold cavity 105 provided at intermediate mold 103.

Then, a resin material heated and molten in a resin material supply pot 108 of lower mold 104 is pressurized by a resin pressurizing plunger 109 to be injected and charged into mold cavity 105 through a lower mold runner 110 and a top gate (sprue) 111 of intermediate mold 103.

After an elapse of time required for curing, mold 101 is opened, so that semiconductor chips 107 are individually encapsulated in individual packages 112 each corresponding to the shape of mold cavity 105, in mold cavity 105.

Here, mold 101 can be opened with a runner resin 113 and a gate resin 114 being adhered and left on the lower mold 104 side. Therefore, individual package 112 cured in mold cavity 105 can be cut off from gate resin 114 cured in top gate 111 at the connection portion.

In this manner, semiconductor chips 107 are individually resin-encapsulated in individual packages 112 in mold cavity 105, thereby forming a molded substrate (for example, comprised of one substrate 106 and three individual packages 112).

The above-noted molded substrate 115 is cut at required places thereby yielding stacking package substrates 116 (for example, comprised of one cut-off substrate 106 and one individual package 112) for use to stack packages 112.

It is noted that in the example shown in FIG. 11, a semiconductor chip 107a fit in cavity 105 on the left side is a flip chip type and a semiconductor chip 107b fit in cavity 105 on the right side is a wire bonding type.

Furthermore, the aforementioned package substrate (stacking package) 116 has stacking connection electrodes (connection electrodes to be used for stacking) (117, 118) attached on the front surface and the back surface of the substrate.

As shown in FIG. 12A, stacking chip-side connection electrode 117 is attached on the semiconductor chip-mounted surface of substrate 106 (the front surface of the substrate, that surface of the substrate on which the chip is provided, the resin surface of the substrate), on the periphery of the semiconductor chip (individual package 112) attached to substrate 106 of stacking package substrate 116.

Stacking non chip-side connection electrode 118 is attached on the non semiconductor chip-mounted surface of substrate 106 (the back surface of the substrate, the ball surface of the substrate).

The aforementioned stacking package substrates 116 are stacked (laid on top of one another) and connection electrodes 117, 118 are electrically connected with other electrodes, resulting in a POP type semiconductor product 131 (see FIG. 12B).

In recent years, in POP type semiconductor product 131 as shown in FIG. 12B, for example, stacking of stacking package substrates (stacking packages) 116 has required that individual packages 112 to be stacked should be reduced in thickness. Therefore, it has been required in the top gate method as described above that package 112 with a small thickness (low in height), a so-called thin package, should be resin-encapsulated.

However, in the resin encapsulation molding by the top gate method, at the time of gate cutting, a projection/depression is easily formed at the gate connection portion (the portion in the vicinity of the gate opening) of individual package 112, causing a problem in quality and reliability of molded substrate (product) 115.

For example, as shown in FIG. 12A, at the time of gate cutting, a defect portion (depression) 121 may be formed at the package in the vicinity of gate resin 114, so that the semiconductor chip (107) in package 112 may be exposed.

In this case, the moisture resistance of package 112 is deteriorated, causing a problem in terms of quality and reliability of the molded substrate (product).

Accordingly, in the top gate method, such a distance (thickness ) that can withstand the impact of gate cutting is required between the top face of semiconductor chip 107 and the gate connection portion of package 112 (that surface of individual package 112 which is opposite to substrate 106).

In other words, since package 112 requires impact resistance against gate cutting, it is unable to efficiently reduce the thickness of package 112. Thus, reduction in thickness of packages is limited when the quality and reliability of molded substrates (products) is taken into consideration.

Moreover, for example, at the time of gate cutting, a gate residue (projection) is formed at the gate connection portion of package 112, so that the gate residue (projection) inhibits efficient stacking when another stacking package substrate is stacked on stacking package substrate 116. Therefore, there has been a problem even in terms of the stackability of packages.

Therefore, in the case where molded substrate 115 (product) having stacking package substrate 116 is resin-encapsulated, in particular, in the case where a thin stacking package substrate is resin-encapsulated, it has been demanded to provide a resin encapsulation molding method of a semiconductor chip and a mold thereof which can provide a high-quality and high-reliability product (molded substrate) without using the top gate method.

Furthermore, conventionally, as described above, in stacking package substrate 116 or a molded substrate (product), stacking connection electrodes (117, 118) are attached on the front and back surfaces of substrate 106.

For example, in stacking package substrate 116 (molded substrate 115), stacking chip-side connection electrode 117 is attached on the periphery of semiconductor chip 107 (package 112) mounted on substrate 106 in order to stack another package substrate on package substrate 116.

However, a resin flash 119 is easily formed and adhered on the surface on which chip-side connection electrode 117 is attached (the resin surface of the substrate), making it impossible to efficiently attach the connection electrode 117.

Therefore, the productivity of products (molded substrate 115) including attachment of stacking connection electrode 117 cannot be improved efficiently.

Furthermore, conventionally, using mold 101 of the top gate method, semiconductor chip 107 and connection electrode 117 attached on the periphery thereof on substrate 106 are resin-encapsulated in individual package 112.

However, in order to expose the tip portion of connection electrode 117, that surface of package (112) which is opposite to substrate 106 has to be polished, making it impossible to efficiently improve the productivity of products (molded substrate 115).

In addition, as described above, conventionally, POP type semiconductor product 131 is formed by stacking and electrically connecting stacking package substrates 116 including stacking connection electrodes 117.

However, as shown in FIG. 12A, distortion easily occurs in molded substrate 115 (stacking package substrate 116) molded by the top gate method, and warpage (shown by reference numeral 120) easily occurs in substrate 106.

Because of this warpage 120, it is impossible to efficiently flatten stacking package substrate 116 and efficiently stack stacking package substrates 116.

Here, although not strictly clarified, presumably, warpage 120 may be caused by the difference between the thermal expansion coefficient of individual package (thermoplastic resin) 112 cured in mold cavity 105 and the thermal expansion coefficient of substrate 106 and by that individual package 112 partially adheres to and covers substrate 106.

In other words, it is assumed that the effect of the difference in thermal shrinkage is partially prominent in molded substrate 115 to cause warpage (distortion) 120, making it impossible to efficiently flatten substrate 106 in molded substrate 115.

Accordingly, unfortunately, substrate 106 in molded substrate (product) 115 cannot be flattened efficiently.

Here, using FIG. 12B, the reason why stacking package substrate 116 cannot be stacked efficiently will be described in detail.

Specifically, in POP type semiconductor product 131 shown in FIG. 12B, a stacking package substrate 132 arranged on the top, package substrate 116 arranged in the middle, and a package substrate 133 arranged at the bottom are stacked.

For example, when substrate 106 in stacking package substrate 116 arranged in the middle suffers warpage 120, a non chip-side connection electrode 134 in stacking package substrate 132 arranged on the top and chip-side connection electrode 117 in stacking package substrate 116 arranged in the middle cannot be electrically connected with each other efficiently.

Furthermore, non chip-side connection electrode 118 in stacking package substrate 116 arranged in the middle and a chip-side connection electrode 135 in stacking package substrate 133 arrange at the bottom cannot be electrically connected with each other efficiently.

In short, because of warpage 120 of substrate 106 in stacking package substrate 116 (molded substrate 115), the connection electrodes cannot be electrically connected efficiently.

Therefore, there has been a demand for a resin encapsulation molding method and a mold thereof which allows molded substrate (product) 115 (and substrate 106 thereof) to be flattened efficiently.

It is noted that in the present application, the aforementioned molded substrate (product) 115 and package substrate 116 formed by cutting this molded substrate 115 have problems in common.

Furthermore, in order to solve the problems as described above, a potting method of dropping a liquid resin onto the top face of a semiconductor chip for molding in a mold cavity and a transfer mold method of injection and charging into a mold cavity from a side gate have been considered. However, the problems such as warpage of substrates have not been solved yet.

### SUMMARY OF THE INVENTION

The present invention is made in order to solve the aforementioned problems, and an object of the present invention is to efficiently improve productivity of products (molded substrates).

Another object of the present invention is to efficiently obtain a high-quality and high-reliability product.

A further object of the present invention is to efficiently obtain a product having a flattened substrate.

Yet another object of the present invention is to efficiently obtain a product having a package with a reduced thickness.

In one aspect, a semiconductor chip compression molding method of compression molding a semiconductor chip mounted on a substrate with a resin material in accordance with the present invention includes the steps of preparing the substrate having the semiconductor chip mounted thereon and provided with a connection electrode on the periphery of the semiconductor chip; and performing the compression molding with a mold release film being pressed into contact with the connection electrode provided on the periphery of the semiconductor chip on the substrate.

In another aspect, a semiconductor chip compression molding method in accordance with the present invention is a method of encapsulating a semiconductor chip in a resin molded body having a shape corresponding to a shape of a mold cavity by compression molding a semiconductor chip mounted on a substrate with a resin material. The method includes the steps of: disposing a required plurality of connection electrodes on the periphery of the semiconductor chip on the substrate; coating a mold release film having a required thickness in the mold cavity; supplying and heating and melting a required amount of resin material in the mold cavity coated with the mold release film; immersing the semiconductor chip and the connection electrode on the periphery thereof in the heated and molten resin material in the mold cavity; and performing the compression molding by pressurizing the heated and molten resin material in the mold cavity by a cavity bottom face member provided on a bottom face of the mold cavity. Then, the connection electrode is pressed into contact with the mold release film during pressurization of the resin material in the mold cavity.

A mold for compression molding of a semiconductor chip in accordance with the present invention includes: a mold cavity for compression molding provided for an openable/closeable mold capable of compression molding a semiconductor chip mounted on a substrate with a resin material and having an opening portion upward; a substrate supply set portion to which the substrate can be supplied and set with the semiconductor chip side facing down; a resin material supply mechanism capable of supplying a required amount of resin material into the mold cavity coated with a mold release film; a heating means capable of heating the resin material in the cavity coated with the mold release film; a clamping mechanism clamping the mold to allow the semiconductor chip mounted on the substrate and a connection electrode to be immersed in a molten resin in the mold cavity; and a cavity bottom face member pressurizing the molten resin in the mold cavity. The mold release film coated in the mold cavity can be pressed into contact with the connection electrode provided on the periphery of the semiconductor chip when the resin in the mold cavity is pressurized.

In the mold for compression molding of a semiconductor chip in accordance with the present invention, a semiconductor chip corresponding portion corresponding to the semiconductor chip and a connection electrode corresponding portion corresponding a stacking connection electrode may be provided in the mold cavity, and in the connection electrode corresponding portion, the connection electrode may be pressed into contact with the mold release film coated in the mold cavity.

Furthermore, in the mold for compression molding of a semiconductor chip in accordance with the present invention, the mold cavity may be formed of a collective cavity collectively corresponding to the semiconductor chip and the connection electrode, and the connection electrode may be pressed into contact with the mold release film coated in the collective cavity.

As described above, the chip-side connection electrode for stacking is attached on the periphery of the semiconductor chip on the substrate and compression molding is performed with the chip-side connection electrode for stacking being pressed into contact with the mold release film, thereby eliminating the step of attaching the chip-side connection electrode for stacking to the molded substrate. Thus, the productivity of products (molded substrates) can be improved efficiently. In addition, the polishing step for exposing the connection electrode can also be eliminated.

Furthermore, by compression molding the semiconductor chip mounted on the substrate, even the problems caused by the conventional top gate method (the moisture resistance of packages and the stackability of packages as described above) can also be solved.

In addition, the chip-side connection electrode for stacking is attached on the periphery of semiconductor chip on the substrate and compression molding is performed with the chip-side connection electrode for stacking being pressed into contact with the mold release film, so that the semiconductor chip-mounted surface side of the substrate (the resin surface side of the substrate) can be coated completely with a resin (the collective resin portion including the flattening reinforcement resin portion). Therefore, the substrate can be reinforced and restrained efficiently by the coating resin to be flattened.

Moreover, in place of the conventional top gate method, the semiconductor chip is compression molded, which eliminates the need for such a package thickness that may withstand cutting of the gate resin. Thus, the distance between the semiconductor chip top face and the cavity bottom face may be reduced, so that a product having a package with a reduced thickness can be obtained efficiently.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic longitudinal sectional view schematically showing a mold for compression molding of a semiconductor chip (a mold for resin encapsulation molding of a semiconductor chip) in accordance with the present invention, showing a mold-opened state before compression molding.

FIG. 2 is a schematic longitudinal sectional view schematically showing the mold corresponding to FIG. 1, showing a mold-clamped state.

FIG. 3 is an enlarged schematic longitudinal sectional view schematically showing an enlarged main portion of the mold shown in FIG. 1, showing a mold-opened state before compression molding.

FIG. 4 is an enlarged schematic longitudinal sectional view schematically showing an enlarged main portion of the mold shown in FIG. 2, showing a mold-clamped state.

FIG. 5 is an enlarged schematic longitudinal sectional view schematically showing an enlarged main portion of the mold corresponding to FIG. 3, showing a mold-opened state after compression molding.

FIG. 6 is a schematic longitudinal sectional view schematically showing another mold for compression molding of a semiconductor chip in accordance with the present invention, showing a mold-opened state before compression molding.

FIG. 7 is a schematic longitudinal sectional view schematically showing the mold corresponding to FIG. 6, showing a mold-clamped state.

FIG. 8 is an enlarged schematic longitudinal sectional view schematically showing an enlarged main portion of the mold shown in FIG. 6, showing a mold-opened state before compression molding.

FIG. 9 is an enlarged schematic longitudinal sectional view schematically showing an enlarged main portion of the mold shown in FIG. 7, showing a mold-clamped state.

FIG. 10 is an enlarged schematic longitudinal sectional view schematically showing an enlarged main portion of the mold corresponding to FIG. 8, showing a mold-opened state after compression molding.

FIG. 11 is a schematic front view schematically showing a mold for resin encapsulation molding of a semiconductor chip according to the conventional top gate method, showing a mold-clamped state.

FIG. 12A is a schematic front view schematically showing a molded substrate (stacking package substrate) resin-encapsulated by the mold shown in FIG. 11, and FIG. 12B is a schematic front view schematically showing a POP (Package On Package) type semiconductor product in which the stacking package substrates shown in FIG. 12A are stacked.

### DESCRIPTION OF THE PREFERRED EMBODIMENTS

A mold for compression molding (mold for resin encapsulation molding of a semiconductor chip) in the present embodiment includes an upper mold, a lower mold, a substrate supply set portion of the upper mold, a lower mold cavity (collective cavity), and a mold release film coated in the lower mold cavity. The mold for compression molding is used to compression-mold a required plurality of semiconductor chips mounted on a substrate and a required plurality of stacking chip-side connection electrodes attached on the periphery of the semiconductor chips.

First, the upper and lower molds are clamped so that the semiconductor chips and the connection electrodes are immersed in a resin material heated and molten in the lower mold cavity coated with the mold release film.

Next, the resin material heated and molten in the cavity coated with the mold release film is pressurized by a cavity bottom face member provided on the cavity bottom face. Thus, the mold release film is pressed and brought into abutment with (pressed into contact with) the tip portion of the connection electrode to allow the tip portion of the connection electrode to be embedded in the mold release film.

After an elapse of time required for curing, the upper and lower molds are opened so that the tip portion of the connection electrode can be exposed. As a result, a sealed substrate (product) can be obtained in which a semiconductor chip and a connection electrode are compression molded in a collective resin portion corresponding to the shape of the lower mold cavity, in the lower mold cavity.

It is noted that the collective resin portion may be comprised of a package portion formed by compression molding a semiconductor chip in a semiconductor chip corresponding portion in a collective cavity (depression) of the mold, and a flattening reinforcement resin portion formed by molding a connection electrode with the tip portion thereof being exposed in a connection electrode corresponding portion in the collective cavity of the mold.

Furthermore, a stacking package substrate can be obtained by cutting the molded substrate (product) at required places.

The height of the connection electrode varies, and the depth of the connection electrode corresponding portion in the collective cavity may be adjusted to the height of the connection electrode. If the connection electrode corresponding portion and the semiconductor chip corresponding portion have the same height, the collective cavity bottom surface is flat.

Since the molded substrate (or stacking package substrate) can be molded with the entire substrate completely coated with the collective resin portion (thermoplastic resin), the entire substrate can efficiently be reinforced and restrained from warpage to be flattened completely by the collective resin portion.

Therefore, a product (molded substrate) having a flattened substrate can be obtained efficiently.

In addition, in the substrate (for example, the flip chip type or the wire bonding type) with a required plurality of semiconductor chips being mounted thereon, a required plurality of stacking chip-side connection electrodes are attached on the periphery of the semiconductor chips (package portions), so that the step of attaching the connection electrode can be eliminated as compared with when the chip-side connection electrode for stacking is attached after resin encapsulation molding.

Accordingly, the step of attaching the connection electrode may be eliminated, thereby efficiently improving productivity of the products (molded substrates).

In addition, a substrate having a required plurality of chip-side connection electrodes for stacking attached in the periphery of the semiconductor chips is used, and compression molding is performed with the mold release film pressed into contact with the tip portion of the connection electrode to expose the tip portion of the connection electrode, so that the step of polishing the package to expose the tip portion of the connection electrode as in the conventional example can be eliminated.

Therefore, the step of polishing the package may be eliminated, thereby efficiently improving productivity of the products (molded substrates).

Furthermore, by compression molding a semiconductor chip, in place of resin encapsulation molding by the top gate method, it is no longer necessary to consider the thickness of the package required for resistance to impact caused by cutting the top gate resin. Accordingly, the package can efficiently be reduced in thickness.

In addition, it is possible to efficiently solve such problems concerning quality and reliability as the decreased moisture-resistance of the package caused by a defect portion (depression) formed at the gate connection portion or the decreased stackability of packages caused by a gate residue (projection).

Accordingly, the problems of moisture-resistance and stackability of packages are solved, and high-quality and high-reliability products can efficiently be obtained.

### First Embodiment

In the following, a first embodiment in accordance with the present invention will be described in detail using the drawings.

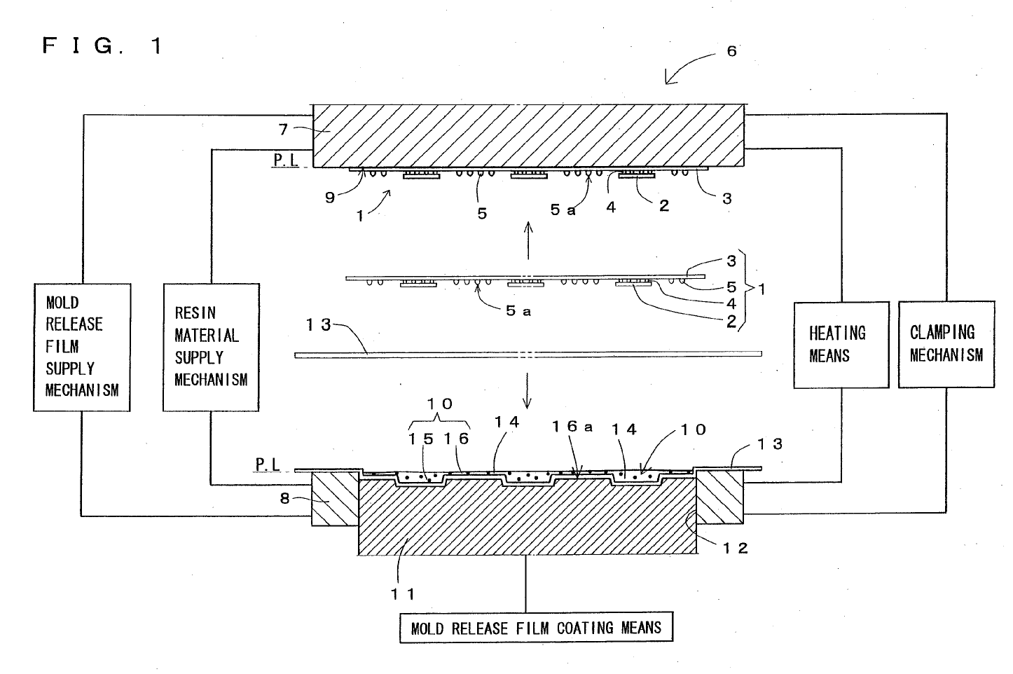

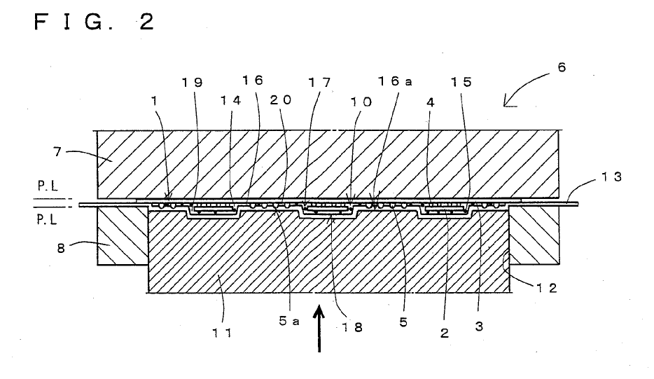

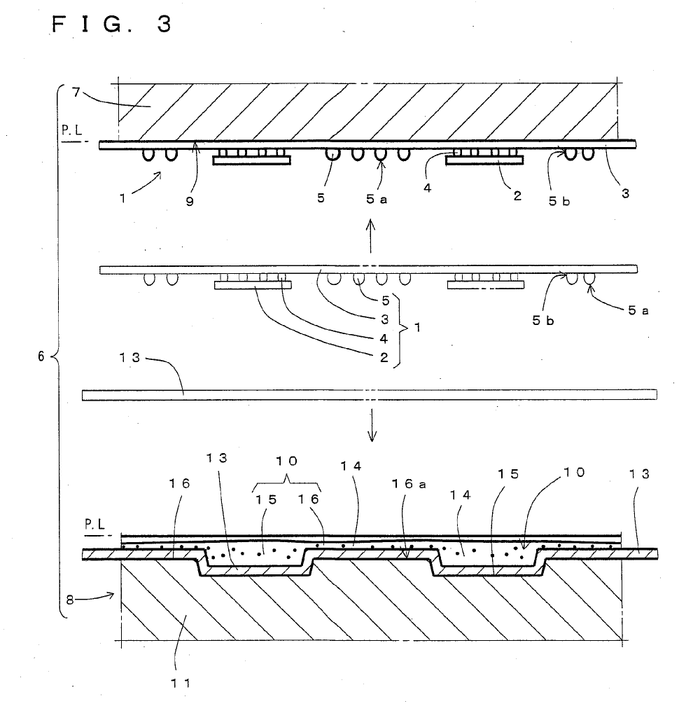

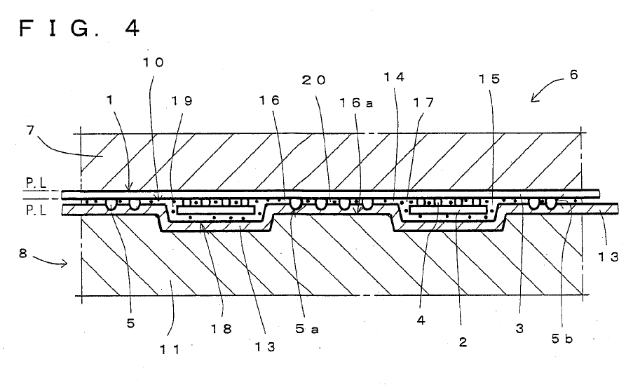

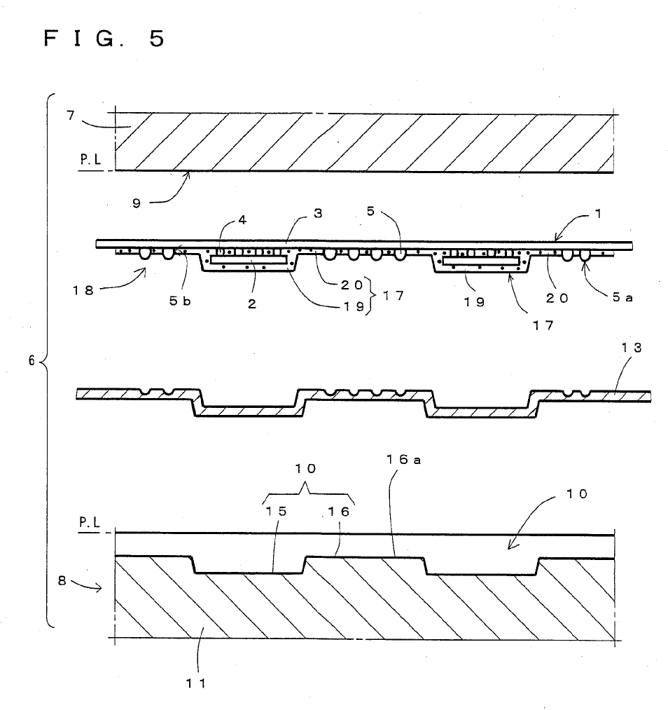

FIG. 1, FIG. 2, FIG. 3, FIG. 4, and FIG. 5 are views showing a mold for compression molding of a semiconductor chip in accordance with the first embodiment.

(Substrate for Use in First Embodiment)

A substrate 1 for use in the first embodiment is a flip chip-type semiconductor chip-mounted substrate 1, as shown in FIG. 1, in which a semiconductor chip 2 and a substrate 3 are electrically connected with each other by a chip connection electrode (connection electrode to be used in the chip) 4.

Furthermore, on the chip-mounted surface of substrate 1 (3), a required plurality of chip-side connection electrodes for stacking (connection electrodes on the chip side to be used for stacking) 5 are provided on the periphery of semiconductor chip 2.

It is noted that the height of semiconductor chip 2 is greater than the height of connection electrode 5.

Using a mold 6 for compression molding of a semiconductor chip, semiconductor chips 2 mounted on the flip chip-type substrate 1 are collectively compression molded while connection electrode for stacking 5 is pressed into contact with a mold release film 13. Accordingly, resin encapsulation molding can be performed with semiconductor chips 2 and connection electrodes 5 coated with a collective resin portion (package portion 19 and flattening reinforcement resin portion 20) corresponding to the shape of collective mold cavity 10 (semiconductor chip corresponding portion 15 and connection electrode corresponding portion 16), resulting in a molded substrate 18.

Here, stacking connection electrode 5 is exposed from collective resin portion 17 (or flattening reinforcement resin portion 20), and resin 14 is injected and charged in the gap (in which chip connection electrode 4 is arranged) between semiconductor chip 2 and substrate 3.

Molded substrate 18 is cut at required places, resulting in a stacking package substrate (including one substrate, one package portion 19, and flattening reinforcement resin portion 20 on the periphery thereof).

(Structure of Mold for Compression Molding of Semiconductor Chip According to First Embodiment)

As shown in FIG. 1, mold 6 for compression molding of a semiconductor chip (mold for resin encapsulation molding of a semiconductor chip) in accordance with the first embodiment includes a fixed upper mold 7 and a movable lower mold 8 arranged to be opposed to upper mold 7.

On a mold surface of upper mold 7, a substrate supply set portion 9 is provided to supply and set substrate 1 with the semiconductor chip 2 side facing down. On a mold surface of lower mold 8, a mold cavity (collective large cavity) 10 for compression molding is provided with an opening portion thereof directed upward.

Mold 6 is provided with a clamping mechanism for clamping upper and lower molds 7 and 8 with a required clamping pressure, a resin supply mechanism supplying a required amount of resin material (14) into lower mold cavity (depression) 10, and a heating means for heating the resin material supplied into lower mold cavity 10.

Furthermore, a cavity bottom face member 11 pressurizing (pressing) resin 14 in lower mold cavity 10 at a required pressure is provided for lower mold 8 in such a manner as to be slidable up and down in a slide hole 12 of the main body of lower mold 8.

Mold 6 is provided with a mold release film supply mechanism supplying and stretching mold release film 13 having a required thickness between the upper and lower molds 7 and 8 and a mold release film coating means for coating lower mold cavity 10 with mold release film 13 by disposing mold release film 13 so as to conform the shape of lower mold cavity 10.

The mold release film coating means includes, for example a mold release film suction fixing means. This suction fixing means may be configured with a suction hole provided at the bottom face of cavity 10 and a vacuum suction mechanism such as a vacuum pump provided at the suction hole. The air is forcedly sucked and evacuated from the bottom face of cavity 10 through the suction hole so that mold release film 3 can be sucked and mold release film 13 can be laid to conform the shape of cavity 10.

By clamping upper and lower molds 7 and 8, semiconductor chip 2 and connection electrode 5 are immersed in resin material 14 heated and molten in lower mold cavity 10 coated with mold release film 13. Next, resin 14 in lower mold cavity 10 is pressurized at a required pressure by cavity bottom face member 11.

Here, at the bottom face of lower mold cavity 10 (bottom face 16a of connection electrode corresponding portion 16), connection electrode 5 is coated and pressed into contact (pressed to be brought into abutment) with mold release film 13.

(Structure of Lower Mold Cavity in First Embodiment)

Lower mold cavity (collective large cavity) 10 in the first embodiment (that is, on the top face side of cavity bottom face member 11) is provided with a semiconductor chip corresponding portion (middle cavity) 15 corresponding to the flip chip-type semiconductor chip 2 and a connection electrode corresponding portion (small cavity) 16 corresponding to stacking connection electrode 5.

As shown in FIG. 1, inside lower mold cavity (depression) 10, the depth of semiconductor chip corresponding portion 15 is relatively deep and the depth of connection electrode corresponding portion 16 is relatively shallow.

Therefore, in the first embodiment, a required plurality of semiconductor chips (three semiconductor chips in the example shown in FIGS. 1 and 2) and connection electrodes 5 on the periphery thereof can be collectively compression molded in collective resin portion 17 corresponding to the shape of lower mold cavity (collective cavity) 10, resulting in molded substrate 18 (one substrate 3 and one collective resin portion 17).

Here, by pressurizing cavity bottom face member 11, mold release film 13 coated on bottom face 16a of connection electrode corresponding portion 16 can be pressed into contact with a tip portion 5a of connection electrode 5 attached to substrate 1 (3) by cavity bottom face member 11.

Collective resin portion 17 is comprised of a package portion 19 (thermoplastic resin with a great height) corresponding to semiconductor chip corresponding portion 15 and a flattening reinforcement resin portion 20 (thermoplastic resin with a small height) corresponding to connection electrode corresponding portion 16.

(Semiconductor Chip Corresponding Portion)

When upper and lower molds 7 and 8 are clamped, semiconductor chip 2 (including chip connection electrode 4) can be fit into a place coated with mold release film 13 in semiconductor chip corresponding portion 15 in lower mold cavity 10 (depression relatively deep in depth in lower mold cavity 10).

Therefore, by clamping upper and lower molds 7 and 8, semiconductor chip 2 can be immersed in heated and molten resin material 14 in semiconductor chip corresponding portion 15 coated with mold release film 13.

Furthermore, by pressurizing heated and molten resin material 14 in semiconductor chip corresponding portion 15 coated with mold release film 13 by cavity bottom face member 11 at a required pressure, package portion (package) 19 can be compression molded (resin-encapsulated). Package portion 19 has a shape corresponding to the shape of semiconductor chip corresponding portion 15 so that the entire semiconductor chip 2 is covered in package portion 19.

Here, resin 14 is injected and charged in the gap (including chip connection electrode 4) between semiconductor chip 2 and substrate 3.

(Connection Electrode Corresponding Portion)

In connection electrode corresponding portion 16 in lower mold cavity 10 (the relatively shallow depression in the lower mold cavity), connection electrode 5 can be fit into connection electrode corresponding portion 16 coated with mold release film 13 by clamping upper and lower molds 7 and 8.

Therefore, connection electrode 5 can be immersed in heated and molten resin material 14 in connection electrode corresponding portion 16 coated with mold release film 13.

Furthermore, by pressurizing heated and molten resin material 14 in connection electrode corresponding portion 16 coated with mold release film 13 by cavity bottom face member 11 at a required pressure, mold release film 13 can be pressed into contact with (pressed to be brought into abutment with) tip portion 5a of connection electrode 5.

Mold release film 13 coating connection electrode corresponding portion 16 is pressed into contact with tip portion 5a of connection electrode 5, so that tip portion 5a of connection electrode 5 can be embedded in mold release film 13.

A flat-shaped resin portion (flattening reinforcement resin portion 20) has a shape corresponding to the shape of connection electrode corresponding portion 16. With a base portion 5b including an intermediate portion of connection electrode 5 buried in flattening reinforcement resin portion 20 and with tip portion Sa of connection electrode 5 exposed in flattening reinforcement resin portion 20, flattening reinforcement resin portion 20 can be compression molded.

(Semiconductor Chip Compression Molding Method in First Embodiment)

As shown in FIG. 1 and FIG. 3, substrate 1 is supplied and set in substrate supply set portion 9 of upper mold 7 with the semiconductor chip 2 side facing down, and at the same time, lower mold cavity (collective cavity) 10 is coated with mold release film 13.

Here, mold release film 13 is arranged on lower mold cavity 10 to conform the shapes of semiconductor chip corresponding portion (deep depression) 15 and connection electrode corresponding portion (shallow depression) 16 in lower mold cavity 10.

Next, a required amount of resin material (14) is supplied in lower mold cavity 10 coated with mold release film 13. More specifically, resin material (14) is supplied to semiconductor chip corresponding portion 15 and connection electrode corresponding portion 16 in lower mold cavity 10. Then, this resin material (14) is heated and molten.

Next, as shown in FIG. 2 and FIG. 4, by clamping upper and lower molds 7 and 8, semiconductor chip 2 and connection electrode 5 are immersed in heated and molten resin material 14 in lower mold cavity 10.

Here, semiconductor chip 2 is immersed in resin 14 in semiconductor chip corresponding portion 15, and connection electrode 5 is also immersed in resin 14 in connection electrode corresponding portion 16.

Next, resin 14 in lower mold cavity 10 is pressurized by cavity bottom face member 11 at a required pressure with mold release film 13 interposed therebetween.

Accordingly, mold release film 13 coating bottom face 16a of connection electrode corresponding portion 16 in lower mold cavity 10 is pressed to be brought into abutment with (pressed into contact with) tip portion 5a of stacking connection electrode 5 mounted on substrate 1, and in addition, tip portion 5a of connection electrode 5 can be embedded in mold release film 13.

Furthermore, semiconductor chip 2 and connection electrode 5 can be compression molded in collective resin portion 17 corresponding to the shape of lower mold cavity 10, and in addition, collective resin portion 17 can be molded to completely coat the semiconductor chip-mounted surface side of substrate 1 of molded substrate (product) 18.

Semiconductor chip 2 is compression molded in package portion 19 corresponding to the shape of semiconductor chip corresponding portion 15, and connection electrode 5 is partially buried in flattening reinforcement resin portion 20 (collective resin portion 17) with tip portion 5a thereof exposed.

Here, resin 14 can be injected and charged in the gap between semiconductor chip 2 and substrate 1 in package portion 19 (collective resin portion 17).

In addition, a required gap is provided between the top face of semiconductor chip 2 and the bottom face of semiconductor chip corresponding portion 15 (the bottom face of lower mold cavity 10).

After an elapse of time required for curing, as shown in FIG. 5, upper and lower molds 7 and 8 are opened. Thus, semiconductor chip 2 and connection electrode 5 mounted on flip chip-type substrate 1 can be held in collective resin portion 17 having the shape corresponding to the shape of lower mold cavity 10. Semiconductor chip 2 is covered with collective resin portion 17 and tip portion Sa of connection electrode 5 is exposed from collective resin portion 17. In this manner, molded substrate 18 can be formed by compression molding (resin encapsulation molding) such that tip portion 5a of connection electrode 5 is exposed from collective resin portion 17.

After molded substrate 18 is formed, molded substrate 18 is cut at required places, thereby yielding stacking package substrates. These stacking package substrates are stacked, resulting in a POP type semiconductor product.

It is noted that in order to expose the top face of semiconductor chip 2, the top face of semiconductor chip 2 can be pressed by the bottom face of semiconductor chip corresponding portion 15 (the bottom face of lower mold cavity 10) with mold release film 13 interposed.

(Working Effect of First Embodiment)

In the first embodiment, collective resin portion 17 molded in lower mold cavity 10 is comprised of package portion 19 corresponding to semiconductor chip corresponding portion 15 and flattening reinforcement resin portion 20 corresponding to connection electrode corresponding portion 16.

Furthermore, in the first embodiment, molding can be performed with the semiconductor chip-mounted surface side of substrate 3 (1) completely coated with (while being adhered to) collective resin material portion 17, and in addition, tip portion 5a of connection electrode 5 can be exposed from flattening reinforcement resin portion 20 of collective resin portion 17.

Since the collective resin portion can be molded all over the substrate, the collective resin portion (thermoplastic resin) can prevent warpage of the substrate thereby flattening the entire substrate, as compared with the case where a part of substrate 106 is coated with package 112 as shown in the conventional example. In addition, the substrate can be reinforced by the collective resin portion. Thus, the substrate can be flattened efficiently while being reinforced, so that a product (molded substrate 18) having the flattened substrate 1 (3) can be obtained efficiently.

Since substrate 1 (3) in molded substrate (product) 18 can be flattened efficiently in this manner, the stackability of packages is good and a high-quality and high-reliability product can be obtained.

Therefore, in accordance with the first embodiment, the products (molded substrates 18) can be stacked efficiently, resulting in a high-quality and high-reliability POP type semiconductor product.

Furthermore, in accordance with the first embodiment, since substrate 3 having semiconductor chip 2 and stacking chip-side connection electrode 5 mounted thereon is compression molded, top gate 111 in the top gate method shown in the conventional example is no longer necessary, thereby efficiently preventing formation of defect portion 121 or the like at the gate connection portion of package 112.

Accordingly, the moisture resistance of the package may also be improved.

Moreover, in accordance with the first embodiment, since top gate 111 is no longer necessary, formation of a gate residue (projection) at the gate connection portion of package 112 can be prevented efficiently.

Therefore, the stackability of packages may also be improved.

In addition, in accordance with the first embodiment, since the stacking chip-side connection electrode 5 is attached on the periphery of semiconductor chip 2 in substrate 1 (3) in advance, the step of attaching connection electrode 5 can be eliminated after semiconductor chip 2 mounted on substrate 3 is compression molded.

Therefore, the productivity of products can also be improved.

In the conventional top gate method, a package is polished in order to expose the connection electrode from the package having a semiconductor chip and a connection electrode buried therein by resin encapsulation molding. However, in accordance with the first embodiment, the polishing step for exposing the connection electrode can be eliminated. This may also contribute to improved productivity.

Furthermore, in the first embodiment, a semiconductor chip mounted on a substrate is compression molded, in place of resin encapsulation molding by the conventional top gate method, so that the thickness of resin that is required for impact resistance at the gate connection portion in a package becomes unnecessary, making it possible to reduce the thickness of a package, efficiently.

In other words, the thickness of resin on the top face side of a semiconductor chip can be reduced. Accordingly, heat dissipation of a package can be improved efficiently (thermal resistance can be decreased).

In addition, since the package can be reduced in thickness, it is also possible to reduce the need for such difficult molding as molding with the top face of a semiconductor chip exposed.

### Second Embodiment

A second embodiment in accordance with the present invention will now be described in detail.

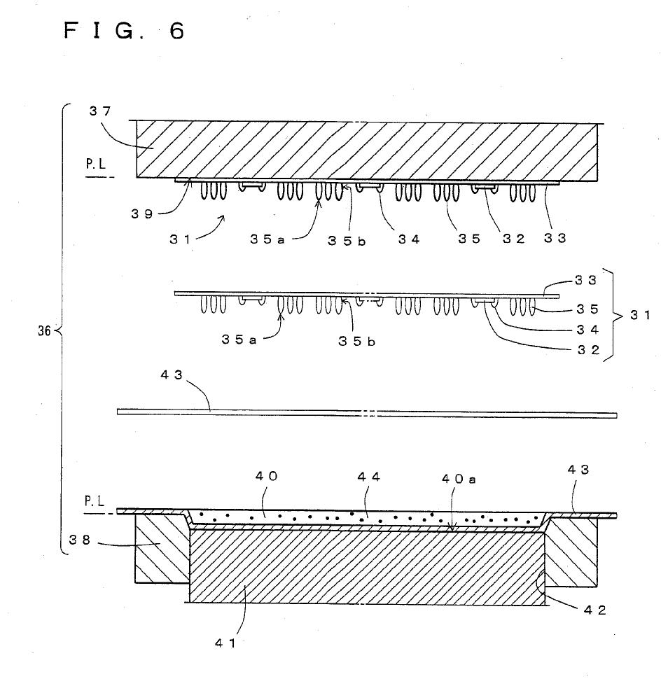

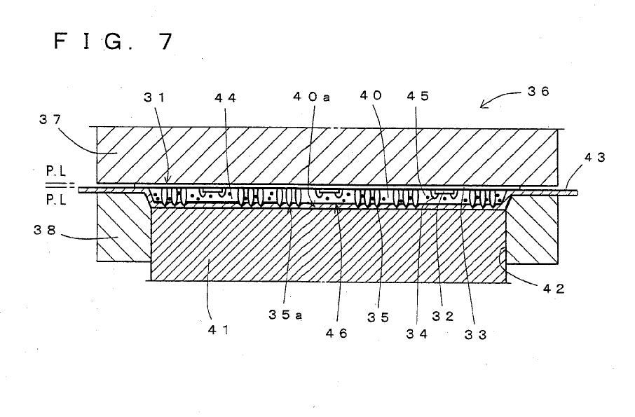

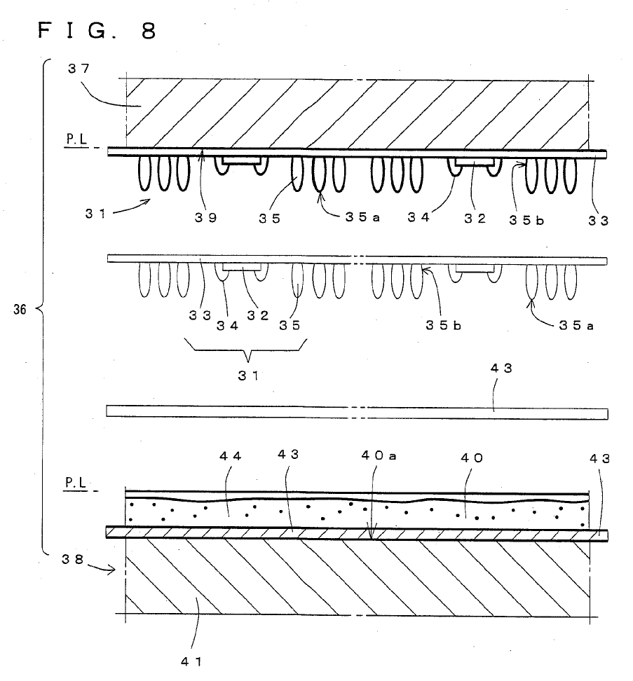

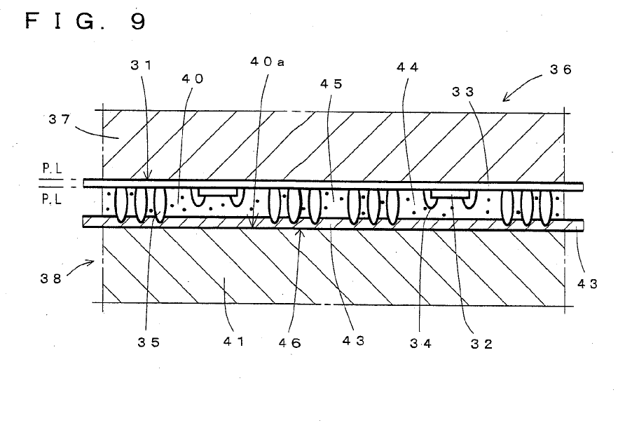

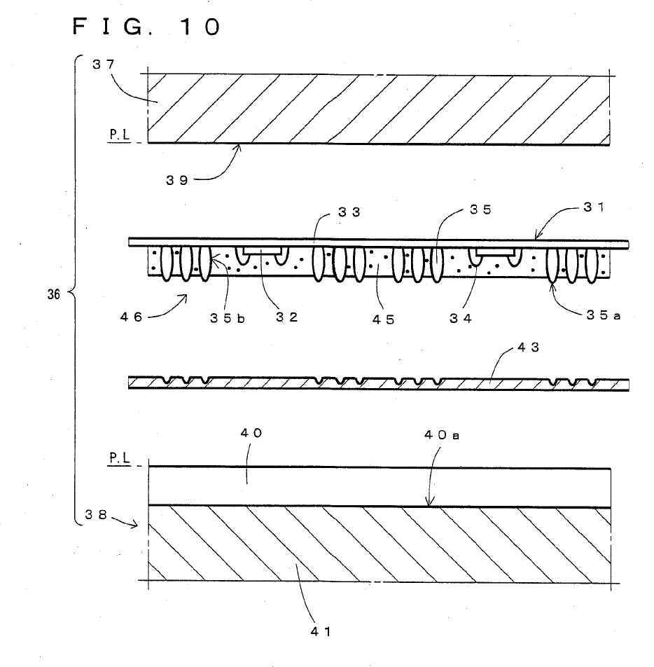

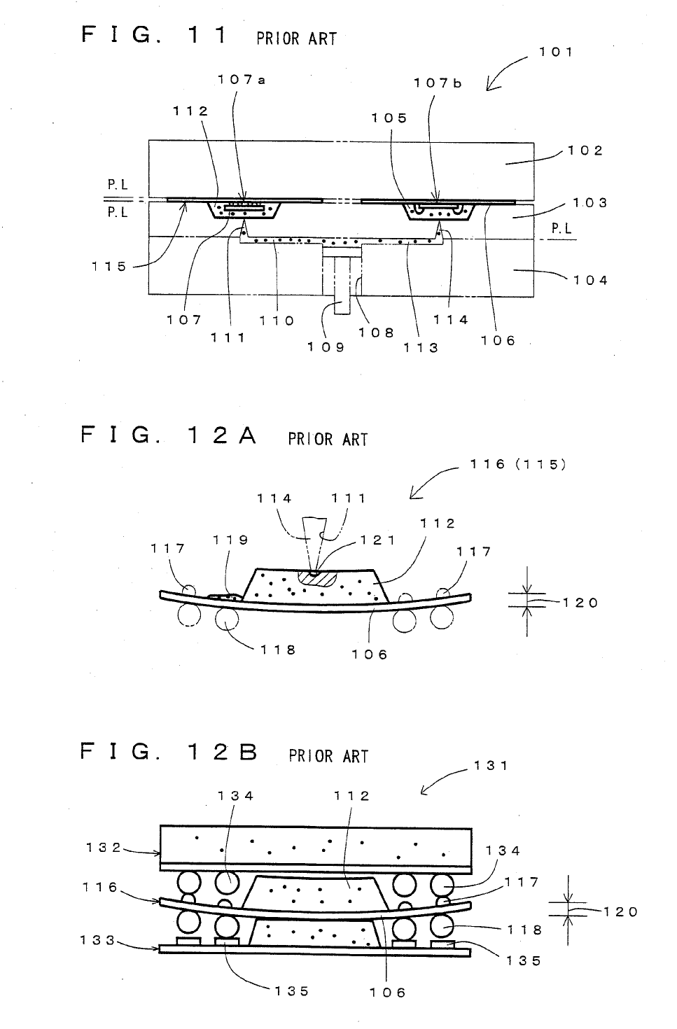

FIG. 6, FIG. 7, FIG. 8, FIG. 9, and FIG. 10 are views showing a mold for compression molding of a semiconductor chip in accordance with the second embodiment.

(Substrate for Use in Second Embodiment)

The substrate for use in the second embodiment is a wire bonding-type semiconductor chip-mounted substrate 31, as shown in FIG. 6, in which a semiconductor chip 32 and a substrate 33 are electrically connected with each other by a metal wire 34.

Furthermore, on the semiconductor chip-mounted surface side of substrate 31 (33), a required plurality of chip-side connection electrodes for stacking 35 are provided on the periphery of semiconductor chip 32.

The height position of chip-side connection electrode 3 5 from the semiconductor chip-mounted surface (substrate 33) is higher than the height position of wire 34.

Using a mold for compression molding for semiconductor chip 32, semiconductor chips 32 mounted on wire bonding-type substrate 31 are collectively compression molded with a mold release film pressed into contact with stacking connection electrode 35. Thus, resin encapsulation molding can be performed with semiconductor chip 32 and connection electrode 35 held in the collective resin portion having the shape corresponding to the shape of the collective mold cavity, resulting in a molded substrate.

Here, connection electrode for stacking 35 is exposed from the collective resin portion, and at the same time, metal wire 34 (semiconductor chip 32) is coated in the collective resin portion.

The above-noted molded substrate is cut at required places, resulting in stacking package substrates.

(Structure of Mold for Compression Molding of Semiconductor Chip According to Second Embodiment)

As shown in FIG. 6, mold 36 for compression molding of a semiconductor chip (mold for resin encapsulation molding of a semiconductor chip) in accordance with the second embodiment includes a fixed upper mold 37 and a movable lower mold 38 arranged to be opposed to upper mold 37, similarly to the first embodiment. On a mold surface of upper mold 37, a substrate supply set portion 39 is provided to supply and set substrate 31 (33) with the semiconductor chip 32 side facing down. On a mold surface of lower mold 38, a mold cavity 40 (collective cavity) is provided with the opening portion thereof open upward.

This mold 36 is provided, although not shown, with a clamping mechanism clamping upper and lower molds 36 (37, 38) at a required clamping pressure, a resin supply mechanism supplying a required amount of resin material into lower mold cavity (depression) 40, and a heating means for heating the resin material supplied in lower mold cavity 40, similarly to the first embodiment.

In addition, similarly to the first embodiment, a cavity bottom face member 41 which pressurizes the resin in lower mold cavity 40 at a required pressure is provided for lower mold 38 in such a manner as to be slidable up and down in a slide hole 42 of the main body of lower mold 38. Mold 36 (37, 38) is provided with a mold release film supply mechanism supplying and stretching a mold release film 43 having a required thickness between upper mold 37 and lower mold 38 and a mold release film coating means (for example, the mold release film suction fixing means shown in the first embodiment) for covering lower mold cavity 40 by laying mold release film 43 on lower mold cavity 40 to conform the shape of lower mold cavity 40.

By clamping upper and lower molds 36 (37, 38), semiconductor chip 32 (metal wire 34) and connection electrode 35 are immersed in resin material 44 heated and molten in lower mold cavity 40 coated with mold release film 43. Then, heated and molten resin 44 in lower mold cavity 40 is pressurized by cavity bottom face member 41 (bottom face 40a of lower mold cavity 40) at a required pressure.

Here, at bottom face 40a of lower mold cavity 40, mold release film 43 can be pressed into contact with (pressed to be brought into abutment with) connection electrode 35 while coating connection electrode 35.

(Structure of Lower Mold Cavity in Second Embodiment)

As shown in FIG. 6, lower mold cavity 40 has the planar (flat) cavity bottom face 40a. By collectively compression molding a required plurality of semiconductor chips 32 mounted on substrate 33 (31) in lower mold cavity 40, semiconductor chips 32 can be resin-encapsulated in collective resin portion 45 having the shape corresponding to the shape of lower mold cavity 40.

Here, resin material 44 heated and molten in lower mold cavity 40 is pressurized by cavity bottom face member 11 (bottom face 40a of cavity 40) with mold release film 43 interposed, so that tip portion 35a can be coated with mold release film 43 while mold release film 43 is pressed to be brought into abutment with (pressed into contact with) tip portion 35a of connection electrode 35.

Furthermore, mold release film 43 is pressed into contact with connection electrode 35, so that tip portion 35a of connection electrode 35 can be embedded in mold release film 43.

Therefore, collective resin portion 45 can be compression molded while a base portion 3 5b including an intermediate portion of connection electrode 35 is buried in collective resin portion 45 and tip portion 35a of connection electrode 35 is exposed from collective resin portion 45.

It is noted that lower mold cavity 40 shown in the second embodiment includes the structure equivalent to semiconductor chip corresponding portion 15 and the structure equivalent to connection electrode corresponding portion 16 as shown in the first embodiment.

Furthermore, collective resin portion 45 shown in the second embodiment has the effect as the package portion (19) in which semiconductor chip 32 is resin-encapsulated and the effect as the flattening reinforcement resin portion (20) (including package portion 19) which efficiently (two-dimensionally) reinforces and restrains the entire substrate 33 (31) completely for flattening, similarly to the first embodiment.

(Semiconductor Chip Compression Molding Method in Second Embodiment)

As shown in FIG. 6 and FIG. 8, substrate 31 (33) is supplied and set in substrate supply set portion 39 of upper mold 37 with the semiconductor chip 32 side facing down, and mold release film 43 is allowed to coat lower mold cavity 40 (the entire collective cavity depression) and adapted to the shape of lower mold cavity 40.

Next, a required amount of resin material (44) is supplied to be heated and molten in lower mold cavity 40 coated with mold release film 43.

Then, as shown in FIG. 7 and FIG. 9, by clamping upper and lower molds 36 (37, 38), semiconductor chip 32 and connection electrode 35 are immersed in heated and molten resin material 44 in lower mold cavity 40.

Next, resin 44 in lower mold cavity 40 is pressurized by cavity bottom face member 41 at a required pressure with mold release film 43 interposed therebetween.

Here, mold release film 43 coated on bottom face 40a (corresponding to bottom face 16a of connection electrode corresponding portion 16 in the first embodiment) in lower mold cavity 40 is pressed to be brought into abutment with (pressed into contact with) tip portion 35a of stacking connection electrode 35. Thus, tip portion 35a of connection electrode 35 can be embedded in mold release film 43.

It is noted that mold release film 43 is arranged so as not to be in contact with wire 34, as a matter of course.

After an elapse of time required for curing, as shown in FIG. 10, upper and lower molds 36 (37, 38) are opened, so that collective resin portion 45 having the shape corresponding to the shape of lower mold cavity 40 is molded. Thus, a molded substrate 46 in which semiconductor chip 32 (wire 34) and connection electrode 35 are compression molded can be formed.

Here, molded substrate 46 can be molded with tip portion 35a of connection electrode 35 exposed from collective resin portion 45.

The aforementioned collective resin portion 45 is molded so as to completely coat the semiconductor chip-mounted surface side of substrate 33 of molded substrate (product) 46 while being adhered thereto.

Even in the second embodiment, the entire substrate 33 (31) is coated with collective resin portion (thermoplastic resin) 45, so that substrate 33 (31) can be flattened while being reinforced as a whole.

It is noted that collective resin portion 45 in the second embodiment includes the package portion (19) corresponding to the semiconductor chip and the flattening reinforcement resin portion (20) corresponding to the connection electrode, similarly to the first embodiment, and collective resin portion 45 has the effect as the package portion (19) and the effect as the flattening reinforcement resin portion (20) in the first embodiment, as a matter of course.

(Working Effect of Second Embodiment)

In accordance with the second embodiment, similarly to the first embodiment, semiconductor chip 32 mounted on substrate 33 (31) can be compression molded (resin-encapsulated) in collective resin portion 45 with tip portion 3 5a of connection electrode 35 exposed from collective resin portion 45 with mold release film 43, so that the working effect similar to the first embodiment can be achieved.

Furthermore, even in the second embodiment, similarly to the first embodiment, substrate 33 (31) can be reinforced and restrained efficiently to be flattened by collective resin portion 45.

Therefore, a product (molded substrate 46) having a flattened substrate can be obtained efficiently.

In addition, since molded substrate 46 can be flattened efficiently, the stackability of packages is good and a high-quality and high-reliability product can be obtained.

Therefore, the products (molded substrates 46) can be stacked efficiently, resulting in a POP type semiconductor product.

Furthermore, similarly to the first embodiment, formation of depression 121 such as a defect portion at the gate connection portion of the package as in the top gate method shown in the conventional example can be prevented efficiently.

Accordingly, the moisture resistance of the package can also be improved.

In addition, formation of a gate residue (protrusion) at the gate connection portion of the package as in the top gate method shown in the conventional example can also be prevented efficiently.

Accordingly, the stackability of packages can also be improved.

Moreover, even the step of attaching connection electrode 35 can be eliminated after semiconductor chip 32 mounted on substrate 33 (31) is compression molded.

Accordingly, even the productivity of products can be improved.

Furthermore, similarly to the first embodiment, the polishing step for exposing the connection electrode can also be eliminated, further improving the productivity of products.

Even in the second embodiment, it is no longer necessary to consider the thickness of the resin required for impact resistance at the gate connection portion in the top gate method shown in the conventional example, so that the distance between the top face of semiconductor chip 32 and cavity bottom face 40a can be reduced thereby efficiently reducing the thickness of the package.

Accordingly, even in the second embodiment, the package can be reduced in thickness and a high-quality and high-reliability product can be obtained efficiently.

(Stacking Package Substrate)

Although in the embodiments described above, the stacking package substrate configured with one substrate and one package (one semiconductor chip) has been illustrated, a stacking package substrate may be configured with one substrate and a plurality of packages.

Furthermore, a required plurality of semiconductor chips may be compression molded in a package (resin molded body) of a stacking package substrate.

(Connection Electrode)

In the embodiments as described above, a solder ball, a metal post, or a stud bump may be employed as a connection electrode attached to that surface of the substrate on which a semiconductor chip is mounted.

(Collective Cavity)

In the embodiments as described above, the collective resin portion having the shape corresponding to the shape of the collective cavity is compression molded in the collective cavity.

In other words, compression molding is performed with the entire substrate being coated with the collective resin portion (thermoplastic resin) completely so that the substrate (molded substrate) can be formed while being reinforced and restrained two-dimensionally (flatly).

Accordingly, the entire substrate can be flattened, and in addition, the substrate can be reinforced.

Furthermore, the collective resin portion molded in the collective cavity is provided with the package portion molded in the semiconductor chip corresponding portion of the collective cavity and with the flattening reinforcement resin portion molded in the connection electrode corresponding portion.

The cavity depth of the semiconductor chip corresponding portion and the cavity depth of the connection electrode corresponding portion are individually set depending on the height of the semiconductor chip and the height of the connection electrode, as shown in the first embodiment, and therefore these depths are usually different from each other. However, as shown in the second embodiment, the depths may be the same.

(Resin Material)

A granular resin material, a powder resin material, a liquid resin material, and a sheet-like resin material may be used as the resin material for use in the foregoing embodiments.

(Decompression Mechanism in Mold Cavity)

In the foregoing embodiments, at least, a decompression mechanism can be provided which sets the pressure in the mold cavity at a required vacuum level by forcedly sucking and evacuating the air in the mold cavity for decompression.

In this case, in order to set the outside air shut-off state in the mold cavity, at least, a seal member such as an 0 ring is preferably disposed on one of the mold surfaces of the upper and lower molds.

In the case where the decompression mechanism as described above is provided, compression molding (resin encapsulation molding) can be performed with a required vacuum level set in the mold cavity, in the foregoing embodiments.

(Other Molds for Compression Molding of Semiconductor Chip)

Although in the foregoing embodiments, a mold structure made of two molds, namely, upper and lower molds has been illustrated, it is possible to use a mold for compression molding of a semiconductor chip, comprised of three molds, namely, an upper mold, an intermediate mold, and a lower mold.

In this case, by clamping the lower mold and the intermediate mold, a mold release film may be sandwiched between the intermediate and lower molds and the inside of the lower mold cavity may be coated with the mold release film.

Even when a mold for compression molding including three molds is used, similarly to the forgoing embodiments, the semiconductor chip mounted on the substrate can be compression molded with the connection electrode being pressed into contact with the mold release film.

The present invention is not limited the foregoing embodiments and the structures of the embodiments can be modified and/or selectively employed arbitrarily and appropriately as necessary without departing from the scope of the present invention.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A semiconductor chip compression molding method of compression molding a semiconductor chip mounted on a substrate with a resin material, comprising the steps of:
preparing said substrate having said semiconductor chip mounted thereon and provided with a connection electrode on a periphery of the semiconductor chip; and
performing said compression molding with a mold release film being pressed into contact with said connection electrode on said substrate.

2. A semiconductor chip compression molding method of encapsulating a semiconductor chip in a resin molded body corresponding to a shape of a mold cavity by compression molding a semiconductor chip mounted on a substrate with a resin material, comprising the steps of:
disposing a required plurality of connection electrodes on a periphery of said semiconductor chip on said substrate;
coating said mold cavity with a mold release film having a required thickness;
supplying and heating and melting a required amount of resin material in said mold cavity coated with said mold release film;
immersing said semiconductor chip and said connection electrode in heated and molten said resin material in said mold cavity; and
performing said compression molding by pressurizing heated and molten said resin material in said mold cavity by a cavity bottom face member provided on a bottom face of said mold cavity,
wherein said connection electrode is pressed into contact with said mold release film during pressurization of said resin material in said mold cavity.

3. A mold for compression molding of a semiconductor chip comprising:
a mold cavity for compression molding provided for an openable/closeable mold capable of compression molding a semiconductor chip mounted on a substrate with a resin material and having an opening portion upward;
a substrate supply set portion to which said substrate can be supplied and set with said semiconductor chip side facing down;
a resin material supply mechanism capable of supplying a required amount of resin material into said mold cavity coated with a mold release film;
a heating means capable of heating said resin material in said mold cavity coated with said mold release film;
a clamping mechanism clamping said mold to allow said semiconductor chip mounted on said substrate and a connection electrode on a periphery thereof to be immersed in a molten resin in said mold cavity; and
a cavity bottom face member pressurizing the molten resin in said mold cavity,
wherein said mold release film can be pressed into contact with said connection electrode when the molten resin in said mold cavity is pressurized by said cavity bottom face member.

4. The mold for compression molding of a semiconductor chip according to claim 3, wherein
a semiconductor chip corresponding portion corresponding to said semiconductor chip and a connection electrode corresponding portion corresponding a connection electrode for stacking are provided in said mold cavity, and
in said connection electrode corresponding portion, said connection electrode is pressed into contact with said mold release film coating said mold cavity.

5. The mold for compression molding of a semiconductor chip according to claim 3, wherein
said mold cavity is formed of a collective cavity collectively corresponding to said semiconductor chip and said connection electrode, and
said connection electrode is pressed into contact with said mold release film coating said collective cavity.
